(19) United States
(12) Patent Application Publication
(10) Pub. No.: US 2014/0063376 A1
(43) Pub. Date: Mar. 6, 2014

(54) LIQUID-CRYSTAL OPTICAL MODULES AND MULTI-PURPOSE EYEWEAR USING THE SAME

(71) Applicants: Wing Hon TSANG, Hong Kong (HK); Ka Lun Chan, Hong Kong (HK)

(72) Inventors: Wing Hon TSANG, Hong Kong (HK); Ka Lun Chan, Hong Kong (HK)

(73) Assignee: 3ND TECHNOLOGY LIMITED, Hong Kong (HK)

(21) Appl. No.: 13/600,189

(22) Filed: Aug. 30, 2012

(51) Int. Cl. G02B 27/22; G02F 1/13

(52) U.S. Cl. CPC G02B 27/2228; G02F 1/1313
USPC 349/13; 349/96; 359/465

(57) ABSTRACT

This invention discloses optical modules, and eyewear using them for performing viewing function(s) including viewing a shutter-based 3D display, viewing a polarization-based 3D display, emulating the Pulfrich effect, emulating a pair of pinhole glasses and emulating a pair of sunglasses. In one embodiment, an optical module comprises: a first liquid crystal layer between a first and a second transparent conductive layers; a transparent protective layer attached to the first transparent conductive layer; a third transparent conductive layer; a matrix-electrode layer, comprising an array of independently addressable electrode regions each being transparent and electrically conductive; a second liquid crystal layer between the matrix-electrode layer and the third transparent conductive layer; a first linear polarizer attached to the second transparent conductive layer and the matrix-electrode layer; and a second linear polarizer, having a polarization orientation orthogonal to the polarization orientation of the first linear polarizer, attached to the third transparent conductive layer.

### FIELD OF THE INVENTION

The present invention relates to liquid-crystal optical modules, and eyewear using such optical modules for performing one or more viewing functions.

### BACKGROUND

Three-dimensional (3D) display of images provides an enhanced enjoyable experience for a viewer watching such images compared to viewing conventional two-dimensional images. To allow the viewer to effectively view a 3D image, slightly different images are presented to the left eye and the right eye of the viewer in order that the viewer perceives an illusionary presence of depth. Hereinafter, a left-eye image and a right-eye image are referred to as images that are intended for seeing by the left eye and the right eye, respectively, of the viewer for producing a 3D perception effect.

In a shutter-based 3D display, the display screen alternately displays left-eye images and right-eye images at different time instants. The viewer is required to wear special eyeglasses having a left-eye lens and a right-eye lens configured to be positioned in front of the left eye and the right eye, respectively, of the viewer. The situation of viewing a shutter-based 3D display is illustrated in FIG. 1. When a left-eye image is displayed on the 3D display, a mechanism is triggered such that the left-eye lens is made transparent whereas the right-eye lens is made opaque. A similar operation is performed by such mechanism when a right-eye image is displayed. By synchronizing the operation of the eyeglasses with the left- and right-eye image display pattern, and by displaying the left- and the right-eye images at a sufficiently high rate, the viewer can perceive the 3D image. This synchronization may be achieved by connecting the display with the eyeglasses by wire, or the eyeglasses may receive the synchronization signal from the display wirelessly.

In a polarization-based 3D display, the left-eye image and the right-eye image are produced by different light beams having mutually orthogonal polarizations. These two images are simultaneously displayed. The situation of viewing a polarization-based 3D display is illustrated in FIG. 2. By placing a polarizer with a polarization orientation the same as that of the left-eye image, the left-eye image is allowed to pass through the polarizer whereas the right-eye image is blocked. A similar operation is used to extract the right-eye image. Therefore, the viewer is allowed to view the 3D image by wearing special eyeglasses where the left- and the right-eye lenses are polarizers having polarization orientations aligned with the polarization orientations of the left- and the right-eye images, respectively.

In an anaglyphic 3D display, the left-eye image and the right-eye image are transmitted in differently-colored light beams and are superimposed together. Extraction of the left- (or right-) eye image from the superimposed image is possible by passing the superimposed image through a color filter having a color matched to the color of the light beam that carries the left- (or right-) eye image. The situation of viewing an anaglyphic 3D display is illustrated in FIG. 3. To enjoy 3D viewing of anaglyphic 3D images, a viewer can wear special eyeglasses having the left- and the right-eye lenses that are color filters matched to the colors of the left- and the right-eye images, respectively.

It is also possible to enable a person to experience a 3D viewing perception by the Pulfrich effect. The Pulfrich effect is a psychophysical phenomenon wherein lateral motion of an object in the field of view is interpreted by the visual cortex as having a depth component, due to a relative difference in signal timings between the two eyes. To achieve the Pulfrich effect, a viewer can wear special eyeglasses having a dark filter placed over one eye. A widely accepted explanation of the apparent depth is that a reduction in retinal illumination (relative to another eye) yields a corresponding delay in signal transmission, imparting instantaneous spatial disparity in moving objects.

For the aforementioned 3D displays and the viewing arrangement based on the Pulfrich effect, the viewer is required to wear eyeglasses specific for each type of display or arrangement that provides a 3D viewing experience. Different pairs of eyeglasses are therefore required. Having different eyeglasses is inconvenient to end users. It is desirable to have a single pair of multi-purpose eyeglasses usable for viewing a variety of 3D displays and/or for inducing the Pulfrich effect.

### SUMMARY OF THE INVENTION

A first aspect of the present invention is a first multi-purpose eyewear for enabling a user to view a shutter-based 3D display when a power source is present, or to view a polarization-based 3D display when the power source is absent. This eyewear comprises a left-eye optical module and a right-eye optical module, each of which is a first liquid-crystal optical module. The first liquid-crystal optical module comprises: a first transparent conductive layer; a second transparent conductive layer; a liquid crystal layer positioned between the first and the second transparent conductive layers; a transparent protective layer attached to the first transparent conductive layer on a surface not attached to the liquid crystal layer; and a linear polarizer characterized by a polarization orientation, attached to the second transparent conductive layer on a surface not attached to the liquid crystal layer. The eyewear further comprises an electronic device configured to: be powered by the power source; receive a synchronization signal from the shutter-based 3D display; supply a first voltage difference between the first and the second transparent conductive layers of the left-eye optical module; and supply a second voltage difference between the first and the second transparent conductive layers of the right-eye optical module. In addition, the eyewear is characterized in that: the linear polarizers of the left-eye and of the right-eye optical modules have mutually orthogonal polarization orientations; when the power source is absent, the electronic device sets both the first voltage difference and the second voltage difference to zero volt, thereby enabling the user to view the polarization-based 3D display; and when the power source is present, the electronic device sets the first voltage difference and the second voltage difference such that an image is allowed to pass through either the left-eye optical module or the right-eye optical module in accordance with the synchronization signal, thereby enabling the user to view the shutter-based 3D display.

Preferably, the electronic device comprises either a radio-frequency wireless receiver or an infra-red receiver for receiving the synchronization signal from the shutter-based 3D display; optionally, both can be included for further compatibility with a wide variety of systems.

A second aspect of the present invention is a second multi-purpose eyewear for enabling a user to view a 3D display that is either a shutter-based 3D display or a polarization-based 3D display, and a second liquid-crystal optical module for realizing this eyewear. This optical module comprises: a transparent conductive layer; a matrix-electrode layer, comprising an array of independently addressable electrode regions each of which is transparent and electrically conductive; a liquid crystal layer positioned between the matrix-electrode layer and the transparent conductive layer; a transparent protective layer attached to the matrix-electrode layer on a surface not attached to the liquid crystal layer; and a linear polarizer characterized by a polarization orientation, attached to the transparent conductive layer on a surface not attached to the liquid crystal layer. The second multi-purpose eyewear comprises: a left-eye optical module and a right-eye optical module each of which is realized as the second liquid-crystal optical module, wherein the linear polarizers of the left- and of the right-eye optical modules have mutually orthogonal polarization orientations; an electronic receiver configured to receive a synchronization signal from the shutter-based 3D display; a first electronic driver for supplying a first reference voltage to the transparent conductive layer of the left-eye optical module, and a second reference voltage to the transparent conductive layer of the right-eye optical module; a digital processing unit, configured to receive the synchronization signal from the electronic receiver, for computing a plurality of digital voltage levels required to drive the independently addressable electrode regions of the left- and the right-eye optical modules for viewing the 3D display that is selected; and a second electronic driver for receiving the plurality of digital voltage levels, generating a plurality of driving voltages according to the plurality of digital voltage levels, and supplying the plurality of driving voltages to drive the independently addressable electrode regions of both optical modules.

A third aspect of the present invention is a third multi-purpose eyewear reconfigurable for performing a viewing function selected from a plurality of available viewing functions, and a third liquid-crystal optical module for realizing this eyewear. This optical module comprises: a first transparent conductive layer; a second transparent conductive layer; a first liquid crystal layer positioned between the first and the second transparent conductive layers; a transparent protective layer attached to the first transparent conductive layer on a surface not attached to the first liquid crystal layer; a third transparent conductive layer; a matrix-electrode layer, comprising an array of independently addressable electrode regions each of which is transparent and electrically conductive; a second liquid crystal layer positioned between the matrix-electrode layer and the third transparent conductive layer; a first linear polarizer characterized by a polarization orientation, attached to the second transparent conductive layer on a surface not attached to the first liquid crystal layer, and attached to the matrix-electrode layer on a surface not attached to the second liquid crystal layer; and a second linear polarizer having a polarization orientation orthogonal to the polarization orientation of the first linear polarizer, the second linear polarizer being attached to the third transparent conductive layer on a surface not attached to the second liquid crystal layer. The third multi-purpose eyewear comprises: a left-eye optical module and a right-eye optical module each of which is realized as the third liquid-crystal optical module, wherein the polarization orientation of the second linear polarizer of the left-eye optical module is orthogonal to the polarization orientation of the second linear polarizer of the right-eye optical module; a first electronic driver for supplying a first reference voltage to the third transparent conductive layer of the left-eye optical module, a second reference voltage to the third transparent conductive layer of the right-eye optical module, a third reference voltage to the second transparent conductive layer of the left-eye optical module, and a fourth reference voltage to the second transparent conductive layer of the right-eye optical module; a digital processing unit for computing a plurality of digital voltage levels required to drive the independently addressable electrode regions and the first transparent conductive layers of the left- and the right-eye optical modules according to the selected viewing function; and a second electronic driver for receiving the plurality of digital voltage levels, generating a plurality of driving voltages according to the plurality of digital voltage levels, and supplying the plurality of driving voltages to drive the independently addressable electrode regions and the first transparent conductive layers of both optical modules.

Preferably, the plurality of available viewing functions includes viewing a shutter-based 3D display and viewing a polarization-based 3D display. It is also preferable that the plurality of available viewing functions further includes one or more viewing functions selected from emulating the Pulfrich effect for 3D viewing, emulating a pair of pinhole glasses and emulating a pair of sunglasses.

A fourth aspect of the present invention is a fourth multi-purpose eyewear reconfigurable for performing a viewing function selected from a plurality of available viewing functions, and a fourth liquid-crystal optical module for realizing this eyewear. This optical module incorporates the disclosed details of the third liquid-crystal optical module, and further comprises a multi-color filtering layer positioned between the first linear polarizer and the matrix-electrode layer, wherein the multi-color filtering layer comprises an array of color filters overlying the array of independently addressable electrode regions. The fourth multi-purpose eyewear comprises: a left-eye optical module and a right-eye optical module each of which is realized as the fourth liquid-crystal optical module, wherein the polarization orientation of the second linear polarizer of the left-eye optical module is orthogonal to the polarization orientation of the second linear polarizer of the right-eye optical module; a first electronic driver for supplying a first reference voltage to the third transparent conductive layer of the left-eye optical module, a second reference voltage to the third transparent conductive layer of the right-eye optical module, a third reference voltage to the second transparent conductive layer of the left-eye optical module, and a fourth reference voltage to the second transparent conductive layer of the right-eye optical module; a digital processing unit for computing a plurality of digital voltage levels required to drive the independently addressable electrode regions and the first transparent conductive layers of the left- and the right-eye optical modules according to the selected viewing function; and a second electronic driver for receiving the plurality of digital voltage levels, generating a plurality of driving voltages according to the plurality of digital voltage levels, and supplying the plurality of driving voltages to drive the independently addressable electrode regions and the first transparent conductive layers of both optical modules.

Preferably, the plurality of available viewing functions includes viewing a shutter-based 3D display and viewing a polarization-based 3D display. It is also preferable that the plurality of available viewing functions further includes one or more viewing functions selected from viewing an anaglyphic 3D display, emulating the Pulfrich effect for 3D viewing, emulating a pair of pinhole glasses and emulating a pair of sunglasses.

A fifth aspect of the present invention is a fifth multi-purpose eyewear reconfigurable for performing a viewing function selected from a plurality of available viewing functions, wherein this eyewear includes a plurality of Fresnel lens to perform one or more optical effects. This eyewear incorporates the disclosed details of the fourth multi-purpose eyewear, and further comprises: a first Fresnel lens, positioned to be adjacent to either the transparent protective layer or the second linear polarizer of the left-eye optical module; and a second Fresnel lens, positioned to be adjacent to either the transparent protective layer or the second linear polarizer of the right-eye optical module; wherein each of the first and the second Fresnel lenses has a focal length that is reconfigurable.

Preferably, the focal lengths of the first and the second Fresnel lenses are configured to correct either short-sightedness or long-sightedness of a user.

Preferably, the plurality of available viewing functions further includes one or more viewing functions selected from viewing an anaglyphic 3D display, emulating the Pulfrich effect for 3D viewing, emulating a pair of pinhole glasses and emulating a pair of sunglasses.

Preferably, the fifth multi-purpose eyewear is further characterized in that: the first Fresnel lens is configured to be positioned between the left-eye optical module and a left eye of a user; and the second Fresnel lens is configured to be positioned between the right-eye optical module and a right eye of the user.

Preferably, the plurality of available viewing functions includes viewing a loaded 3D image sequence.

Preferably, the plurality of available viewing functions includes viewing a shutter-based 3D display and viewing a polarization-based 3D display.

Preferably, each of the first and the second Fresnel lenses comprises an array of liquid lenses.

### BRIEF DESCRIPTION OF THE DRAWINGS

FIG. 1 illustrates a situation of viewing a shutter-based 3D display.

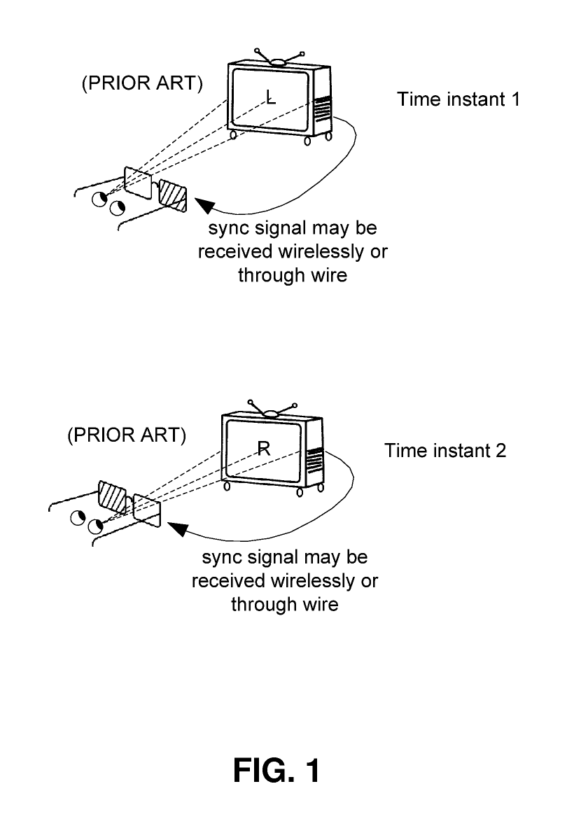

FIG. 2 illustrates a situation of viewing a polarization-based 3D display.

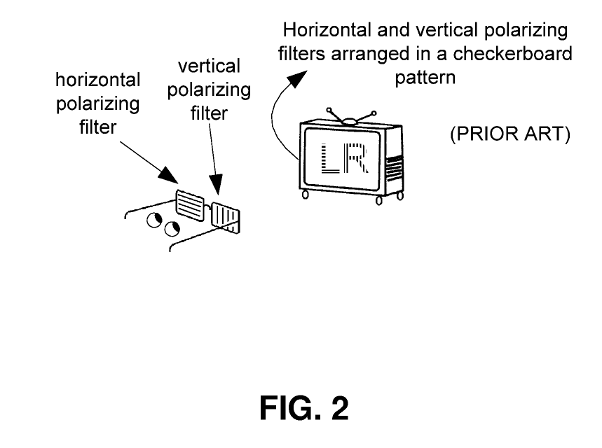

FIG. 3 illustrates a situation of viewing an anaglyphic 3D display.

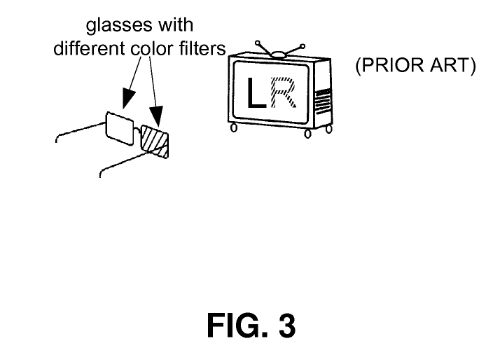

FIG. 4 depicts an optical module that is used in eyewear according to a first aspect of the present invention.

FIG. 5 is a schematic diagram of eyewear according to the first aspect of the present invention. This eyewear is for enabling a user to view a shutter-based 3D display when a power source is present, or to view a polarization-based 3D display when the power source is absent.

FIG. 6 depicts an optical module according to a second aspect of the present invention. A three-dimensional view of a matrix-electrode layer used in this optical module is also shown.

FIG. 7 is a schematic diagram of eyewear according to the second aspect of the present invention. This eyewear is for enabling a user to view a 3D display that is either a shutter-based 3D display or a polarization-based 3D display.

FIG. 8 depicts an optical module according to a third aspect of the present invention. This optical module is developed substantially based on combining the two optical modules according to the first and the second aspects of this invention.

FIG. 9 is a schematic diagram of eyewear according to the third aspect of the present invention. This eyewear, being reconfigurable, is for performing a viewing function selected from a plurality of available viewing functions.

FIG. 10 depicts an optical module according to a fourth aspect of the present invention. This optical module is developed on the optical module according to the third aspect of the present invention with an addition of a multi-color filtering layer.

FIG. 11 is a prior-art realization of a Fresnel lens for illustration purposes.

FIG. 12 is a schematic diagram of eyewear according to a fifth aspect of the invention. This eyewear is developed on the eyewear according to the fourth aspect of the present invention with an addition of a plurality of Fresnel lenses having their focal lengths that are reconfigurable.

FIG. 13 is one realization of a Fresnel lens having a reconfigurable focal length. This realization is based on an array of liquid lenses.

### DETAILED DESCRIPTION OF THE PREFERRED EMBODIMENTS

As used herein, in the context of the present invention, the term “eyewear” relates to any type of optical filtering device which can be used to produce a 3D viewing effect when used in combination with a displayed image. The “eyewear” may be “wearable” as with eyeglasses or other head-mountable lens structures or, alternatively, the “eyewear” may be supported by an object other than the user in such a way that each eye of the user experiences the desired filtering effects to create 3D perception.

In the present invention, a “liquid crystal layer” refers to a layer substantially composed of liquid-crystal molecules wherein the liquid crystal layer is configured to provide a 90-degree polarization shift to a light beam that passes through this liquid crystal layer when a voltage difference between two opposite surfaces of the liquid crystal layer is zero volt. It is possible to apply a non-zero voltage difference to the two opposite surfaces of the liquid crystal layer. Furthermore, it is possible to partition the liquid crystal layer into a plurality of “liquid crystal cells” each of which can be individually applied with a voltage difference between two opposite surfaces thereof. It is used herein that an “untwisting voltage” refers to a voltage sufficiently large to cause a substantial portion of liquid-crystal molecules in a liquid crystal layer or a liquid crystal cell to be reoriented, such that no polarization shift is provided to a light beam that passes through the liquid crystal layer. No polarization shift also results if an external voltage difference is applied between two opposite surfaces of a liquid crystal layer or a liquid crystal cell, where this voltage difference has a magnitude exceeding the untwisting voltage. If this voltage difference has a magnitude between zero volt and the untwisting voltage, the intensity of a light beam passing through the liquid crystal layer or the liquid crystal cell is modulated, thereby providing a method to control the intensity of the light beam.

It is an observation that a present-day shutter-based 3D display is usually a liquid-crystal display so that images produced by such display are produced in polarized light having one polarization orientation. In the present invention, it is considered that a left-eye image and a right-eye image sent out by a shutter-based 3D display are carried by light beams that are linear polarized light having the same polarization orientation. For example, this polarization orientation may be either horizontal polarization or vertical polarization.

In the present invention, it is also considered that a left-eye image and a right-eye image sent out by a polarization-based 3D display are carried by light beams that are linear polarized lights having mutually orthogonal polarization orientations.

As mentioned above, a left-eye image and a right-eye image refer to images that are intended for seeing by a left eye and a right eye, respectively, of a viewer for producing a 3D perception effect. In the description of the embodiments that follow, it is considered that the disclosed eyewear is configured to present the left-eye image to the left eye and the right-eye image to the right eye. Nonetheless, the viewer may, at his or her wish, reconfigure the disclosed eyewear to present the left-eye image to the right eye while the right-eye image is presented to the left eye. This reconfiguration becomes apparent to an ordinary person skilled in the art after reading the disclosure of the present invention.

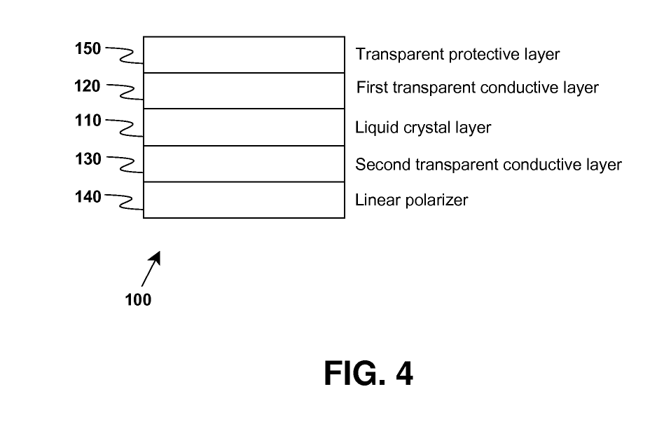

A first aspect of the present invention is to disclose a first multi-purpose eyewear for enabling a user to view a shutter-based 3D display when a power source is present, or to view a polarization-based 3D display when the power source is absent. This eyewear is realized based on a first liquid-crystal optical module depicted in FIG. 4.

Refer to FIG. 4. An optical module 100, which is the first liquid-crystal optical module, comprises a liquid crystal layer 110 positioned between a first transparent conductive layer 120 and a second transparent conductive layer 130. Both the first transparent conductive layer 120 and the second transparent conductive layer 130 are optically transparent and electrically conductive. The optical module 100 further comprises a linear polarizer 140, which is characterized by a polarization orientation, and a transparent protective layer 150. The linear polarizer 140 is attached to the second transparent conductive layer 130 on a surface not attached to the liquid crystal layer 110. The linear polarizer 140 is an optical filter that selectively allows a light beam having a polarization orientation the same as the polarization orientation of the linear polarizer 140 to pass through. The transparent protective layer 150 is attached to the first transparent conductive layer 120 on a surface not attached to the liquid crystal layer 110. This transparent protective layer 150 is for providing mechanical support and protection to the rest of the optical module 100.

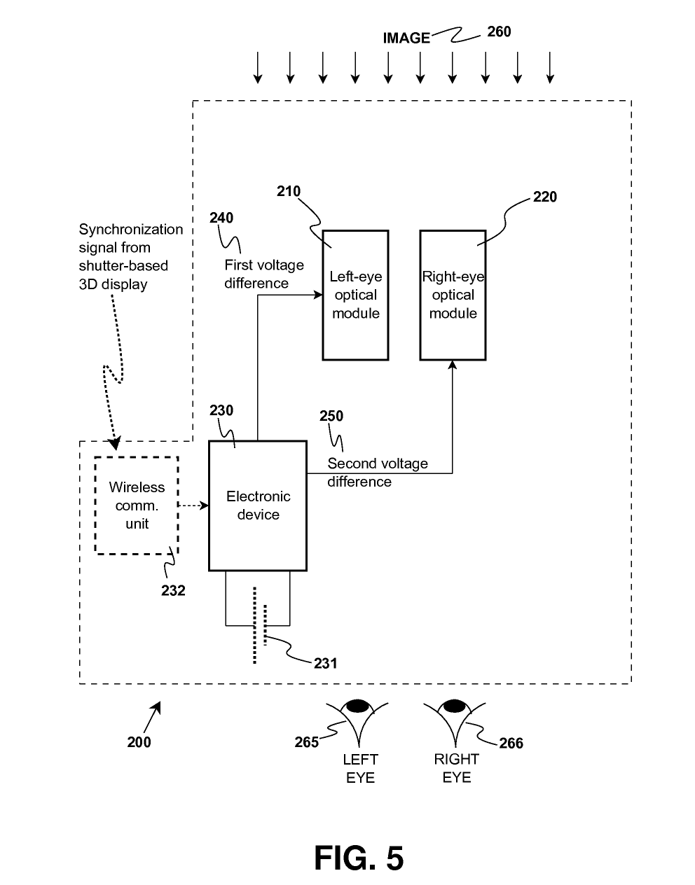

FIG. 5 is a schematic diagram of an eyewear 200 according to the first aspect of the present invention. As is mentioned above, this eyewear 200 enables a user to view a shutter-based 3D display when a power source is present, or to view a polarization-based 3D display when the power source is absent. The eyewear 200 comprises a left-eye optical module 210 and a right-eye optical module 220, each of which is realized according to the optical module 100 described above. The left-eye optical module 210 is configured to be positioned in front of a left eye 265 of the user. Similarly, the right-eye optical module 220 is configured to be positioned in front of a right eye 266 of the user. A light beam carrying an image 260 enters into the left-eye optical module 210 and the right-eye optical module 220. In particular, both optical modules 210, 220 are oriented to receive the light beam by their transparent protective layers. After the left-eye optical module 210 produces a first optical effect on the image 260, the resultant image is seen by the left eye 265 of the user. Similarly, a second optical effect is produced on the image 260 by the right-eye optical module 220 and the resultant image leaving from the right-eye optical module 220 is seen by the right eye 266 of the user. The eyewear 200 further comprises an electronic device 230. This electronic device 230 is configured to be powered by a power source 231. It is possible that the power source 231 is present or absent. If the power source 231 is absent, the electronic device 230 is not supplied with a power. The electronic device 230 is further configured to: receive a synchronization signal from the shutter-based 3D display; supply a first voltage difference 240 between the first and the second transparent conductive layers of the left-eye optical module 210; and supply a second voltage difference 250 between the first and the second transparent conductive layers of the right-eye optical module 220. Furthermore, the eyewear 200 is characterized in that the linear polarizers of the left-eye optical module 210 and of the right-eye optical module 220 have mutually orthogonal polarization orientations.

Consider a situation that the power source 231 is absent and the image 260 is originated from the polarization-based 3D display. The image 260 is a composite image comprising a left-eye image and a right-eye image superimposed together, wherein the left-eye image and the right-eye image are carried by different light beams having mutually orthogonal polarization orientations. As a result that the electronic device 230 does not receive power, the electronic device 230 sets both the first voltage difference 240 and the second voltage difference 250 to zero volt, so that the liquid crystal layer of either the left-eye optical module 210 or the right-eye optical module 220 provides a 90-degree polarization shift to a light beam that passes through such liquid crystal layer. Consequently, the left-eye optical module 210 allows either the left-eye image or the right-eye image to pass through but not both, and the one of the aforesaid two images that is allowed to pass through is carried by a light beam whose polarization orientation is orthogonal to the polarization orientation of the linear polarizer of the left-eye optical module 210. In addition, the one of the aforesaid two images that is not allowed to pass through the left-eye optical module 210 is allowed to pass through the right-eye optical module 220. Hence, the two eyes of the user are allowed to see separate images, the sum of said separate images constituting the image 260, which originates from the polarization-based 3D display. Thereby, the user is enabled to view the polarization-based 3D display. Optionally, the user may equip with a first eyewear and a second eyewear, each of which is a realization of the eyewear 200. The first eyewear and the second eyewear are further characterized in that the linear polarizer of the left-eye optical module of the first eyewear is orthogonal in polarization orientation to that of the second eyewear, also implying that the linear polarizer of the right-eye optical module of the first eyewear is orthogonal in polarization orientation to that of the second eyewear. Therefore, either the first eyewear or the second eyewear allows the left-eye image to pass through the left-eye optical module 210 for the left eye 265 to see, and the right-eye image to pass through the right-eye optical module 220 for the right eye 266 to see. Thus, the user is enabled to view the polarization-based 3D display with the left-eye image and the right-eye image correctly projected to the two eyes of the user.

Consider another situation that the power source 231 is present and the image 260 is originated from the shutter-based 3D display. In the presence of the power source 231, the electronic device 230 sets the first voltage difference 240 and the second voltage difference 250 such that the image 260 is allowed to pass through either the left-eye optical module 210 or the right-eye optical module 220 in accordance with the shutter-based 3D display's synchronization signal received by the electronic device 230. To illustrate how the eyewear 200 facilitates viewing of the shutter-based 3D display, consider a representative case that light beams carrying both the left-eye image and the right-eye image have a common polarization orientation the same as the polarization orientation of the linear polarizer of, say, the left-eye optical module 210. When the synchronization signal indicates that the shutter-based 3D display is sending out the left-eye image, the electronic device 230 may set the first voltage difference 240 and the second voltage difference 250 to a voltage whose magnitude exceeds the untwisting voltage. It follows that no polarization shift to the light beams is introduced by the liquid crystal layers of both the left-eye optical module 210 and the right-eye optical module 220. Since the linear polarizers of both optical modules 210, 220 are mutually orthogonal in polarization orientation, and since the common polarization orientation of the carrier light beams is the same as the polarization orientation of the linear polarizer of the left-eye optical module 210, the left-eye image can pass through the left-eye optical module 210 and is presented to the left eye 265 while this image is blocked at the right-eye optical module 220. When the synchronization signal indicates that the shutter-based 3D display is sending out the right-eye image, the electronic device 230 may set the first voltage difference 240 and the second voltage difference 250 to zero volt. It follows that a 90-degree polarization shift to the carrier light beams is introduced by the liquid crystal layers of either the left-eye optical module 210 or the right-eye optical module 220. Hence, the right-eye image can pass through the right-eye optical module 220 and is presented to the right eye 266 while this image is blocked at the left-eye optical module 210. Therefore, the eyewear 200 enables the user to view the shutter-based 3D display. Optionally, the first voltage difference 240 and the second voltage difference 250 can be operated independently for applying to the left-eye optical module 210 and the right-eye optical module 220, respectively, to block the image 260 to go to both eyes 265, 266 and hence stop the cross-talk produced when a transient switch between the left-eye image to the right-eye image or vice versa when viewing the shutter-based 3D display. In order to block both eyes from seeing the image 260, according to aforesaid case, the first voltage difference 240 is applied with a zero voltage to the left-eye optical module 210 for blocking the left eye 265, and the second voltage difference 250 is applied with a voltage exceeding the untwisting voltage to the right-eye optical module 220 for blocking the right eye 266 at the same time instant. In another case, the first voltage difference 240 and the second voltage difference 250 may be operated to let the image 260 carried by a polarized light beam go to both eyes 265, 266 for non-3D content from a display.

As mentioned above, the electronic device 230 may receive the synchronization signal from the shutter-based 3D display wirelessly or by wire. If the synchronization signal is received wirelessly, the electronic device 230 further comprises a wireless communication unit 232. The wireless communication unit 232 may be a radio-frequency wireless receiver or an infra-red receiver.

A second aspect of the present invention is to disclose a second multi-purpose eyewear for enabling a user to view a 3D display, and a second liquid-crystal optical module for realizing this eyewear, wherein the 3D display is either a shutter-based 3D display or a polarization-based 3D display.

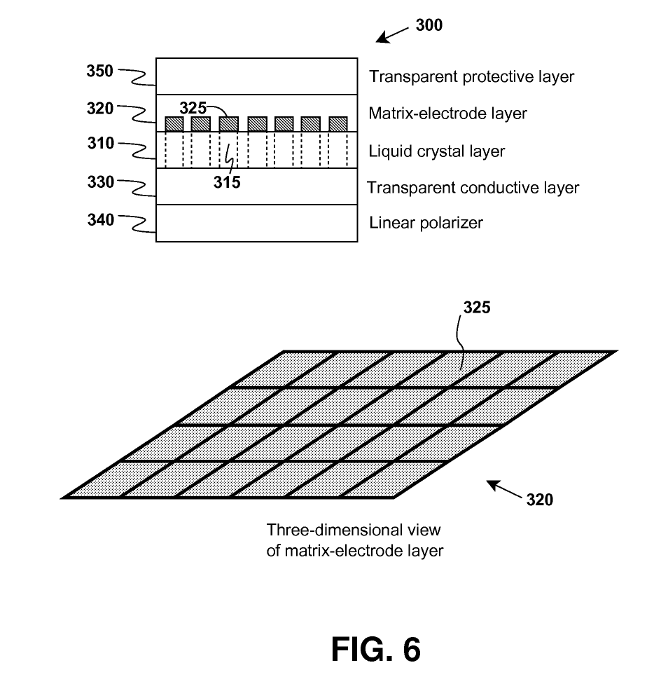

FIG. 6 depicts an optical module 300 according to the second aspect of the present invention. This optical module 300 comprises a liquid crystal layer 310 positioned between a matrix-electrode layer 320 and a transparent conductive layer 330. The transparent conductive layer 330 is optically transparent and electrically conductive. The matrix-electrode layer 320 comprises an array of independently addressable electrode regions 325, and each of the independently addressable electrode regions 325 is optically transparent and electrically conductive. Furthermore, the independently addressable electrode regions 325 are allowed to be addressable such that a voltage can be applied to any one of these independently addressable electrode regions 325 being addressed. As the liquid crystal layer 310 is positioned between the matrix-electrode layer 320 and the transparent conductive layer 330, a plurality of liquid crystal cells 315 is formed, each of which is a portion of the liquid crystal layer 310 contacted with an independently addressable electrode region 325 of the matrix-electrode layer 320. The optical module 300 further comprises a linear polarizer 340, which is characterized by a polarization orientation, and a transparent protective layer 350. The linear polarizer 340 is attached to the transparent conductive layer 330 on a surface not attached to the liquid crystal layer 310. The linear polarizer 340 is an optical filter that selectively allows a light beam having a polarization orientation the same as the polarization orientation of the linear polarizer 340 to pass through. The transparent protective layer 350 is attached to the matrix-electrode layer 320 on a surface not attached to the liquid crystal layer 310. This transparent protective layer 350 is for providing mechanical support and protection to the rest of the optical module 300.

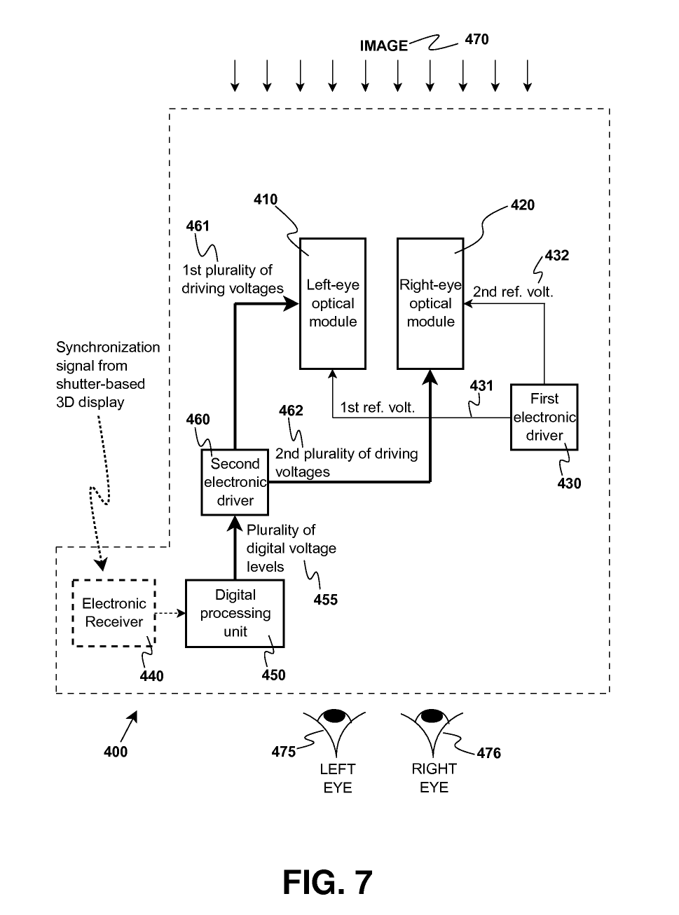

FIG. 7 is a schematic diagram of an eyewear 400 according to the second aspect of the present invention. This eyewear 400 comprises a left-eye optical module 410 and a right-eye optical module 420, each of which is realized as the optical module 300 described above, wherein the linear polarizers of the left-eye optical module 410 and of the right-eye optical module 420 have mutually orthogonal polarization orientations. The left-eye optical module 410 is configured to be positioned in front of a left eye 475 of the user. Similarly, the right-eye optical module 420 is configured to be positioned in front of a right eye 476 of the user. A light beam carrying an image 470 enters into the left-eye optical module 410 and the right-eye optical module 420. In particular, both optical modules 410, 420 are oriented to receive the light beam by their transparent protective layers. After the left-eye optical module 410 produces a first optical effect on the image 470, the resultant image is seen by the left eye 475 of the user. Similarly, a second optical effect is produced on the image 470 by the right-eye optical module 420 and the resultant image leaving from the right-eye optical module 420 is seen by the right eye 476 of the user. The eyewear 400 further comprises a first electronic driver 430, an electronic receiver 440, a digital processing unit 450 and a second electronic driver 460. The first electronic driver 430 supplies a first reference voltage 431 to the transparent conductive layer of the left-eye optical module 410, and a second reference voltage 432 to the transparent conductive layer of the right-eye optical module 420. Optionally, the first reference voltage 431 is equal to the second reference voltage 432. The electronic receiver 440 is configured to receive a synchronization signal from the shutter-based 3D display. Note that if the polarization-based 3D display is selected for viewing, the shutter-based 3D display may not be present so that the synchronization signal may not be received. The electronic receiver 440 is linked to the digital processing unit 450, and sends the synchronization signal, if received, to the digital processing unit 450. According to the synchronization signal if received, and according to the first reference voltage 431 and the second reference voltage 432, the digital processing unit 450 computes a plurality of digital voltage levels 455 required to drive the independently addressable electrode regions of the left-eye optical module 410 and of the right-eye optical module 420 for viewing the 3D display that is selected. The plurality of digital voltage levels 455 is computed based on a substantially similar approach as set out in the first aspect of the present invention regarding the setting of the first voltage difference and the second voltage difference for both cases of the polarization-based 3D display and of the shutter-based 3D display. The second electronic driver 460 receives the plurality of digital voltage levels 455, generates a plurality of driving voltages according to the plurality of digital voltage levels 455, and supplies the plurality of driving voltages to drive the independently addressable electrode regions of both optical modules 410, 420. The plurality of driving voltages consists of a first plurality of driving voltages 461 supplied to the left-eye optical module 410, and a second plurality of driving voltages 462 supplied to the right-eye optical module 420.

Optionally, the left-eye optical module 410 and the right-eye optical module 420 may provide an additional effect of masking the image 470 by selectively making the liquid crystal cells of the two optical modules 410, 420 opaque according to a masking pattern before being viewed by the left eye 475 and the right eye 476, respectively, of a user.

A third aspect of the present invention is to disclose a third multi-purpose eyewear reconfigurable for performing a viewing function selected from a plurality of available viewing functions, and a third liquid-crystal optical module for realizing this eyewear.

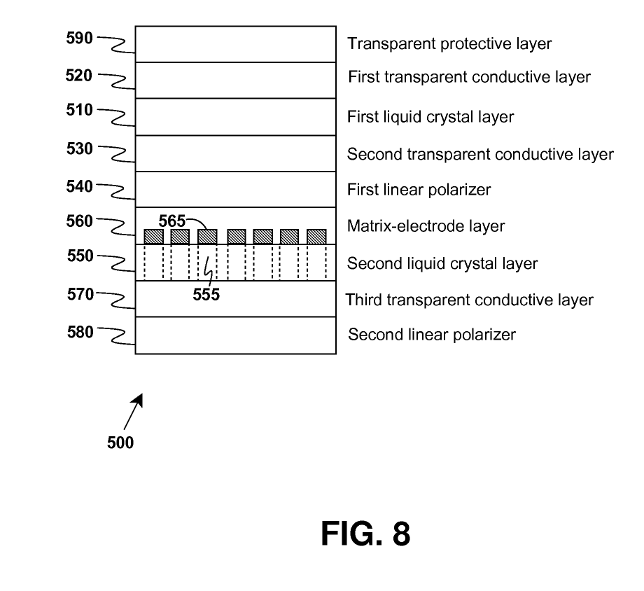

FIG. 8 depicts an optical module 500 according to the third aspect of the present invention. This optical module 500 is substantially similar to a combination of the optical modules 100, 300 with the following additional features. The optical module 500 comprises a first liquid crystal layer 510 positioned between a first transparent conductive layer 520 and a second transparent conductive layer 530. Both the first transparent conductive layer 520 and the second transparent conductive layer 530 are optically transparent and electrically conductive. The optical module 500 further comprises a first linear polarizer 540, which is characterized by a polarization orientation. The first linear polarizer 540 is attached to the second transparent conductive layer 530 on a surface not attached to the first liquid crystal layer 510. The first linear polarizer 540 is an optical filter that selectively allows a light beam having a polarization orientation the same as the polarization orientation of the first linear polarizer 540 to pass through. The optical module 500 further comprises a second liquid crystal layer 550 positioned between a matrix-electrode layer 560 and a third transparent conductive layer 570. The third transparent conductive layer 570 is optically transparent and electrically conductive. The matrix-electrode layer 560 comprises an array of independently addressable electrode regions 565, and each of the independently addressable electrode regions 565 is optically transparent and electrically conductive. Furthermore, the independently addressable electrode regions 565 are allowed to be addressable such that a voltage can be applied to any one of these independently addressable electrode regions 565 being addressed. As the second liquid crystal layer 550 is positioned between the matrix-electrode layer 560 and the third transparent conductive layer 570, a plurality of liquid crystal cells 555 is formed, each of which is a portion of the second liquid crystal layer 550 contacted with an independently addressable electrode region 565 of the matrix-electrode layer 560. The optical module 500 further comprises a second linear polarizer 580, which is characterized by a polarization orientation, and a transparent protective layer 590. The second linear polarizer 580 is attached to the third transparent conductive layer 570 on a surface not attached to the second liquid crystal layer 550. The second linear polarizer 580 is an optical filter that selectively allows a light beam having a polarization orientation the same as the polarization orientation of the second linear polarizer 580 to pass through. In addition, the second linear polarizer 580 and the first linear polarizer 540 are mutually orthogonal in polarization orientation. The transparent protective layer 590 is attached to the first transparent conductive layer 520 on a surface not attached to the first liquid crystal layer 510. This transparent protective layer 590 is for providing mechanical support and protection to the rest of the optical module 500.

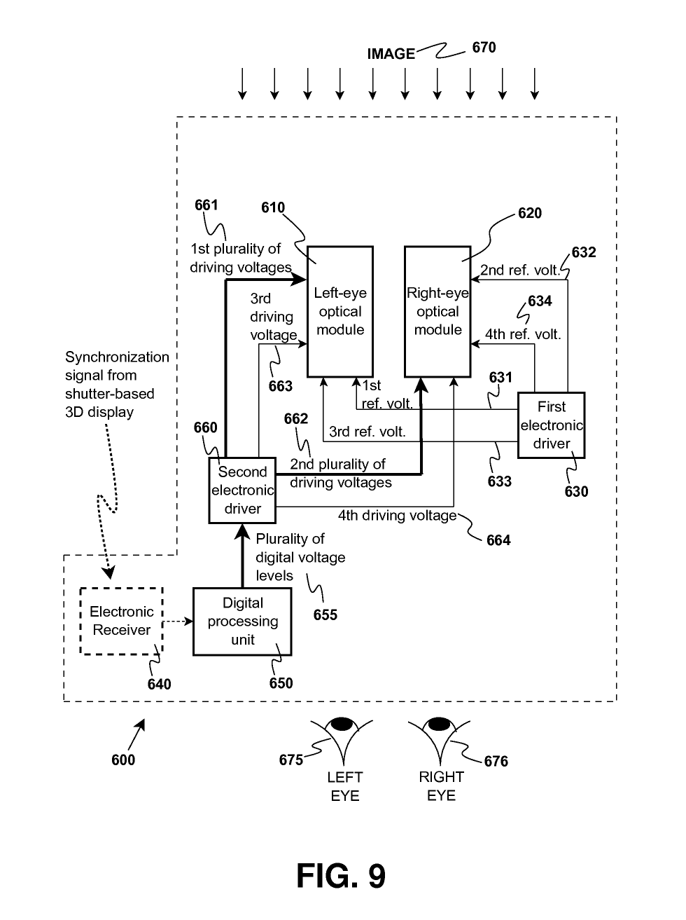

FIG. 9 is a schematic diagram of an eyewear 600 according to the third aspect of the present invention. This eyewear 600 comprises a left-eye optical module 610 and a right-eye optical module 620, each of which is realized as the optical module 500 described above, wherein the second linear polarizers of the left-eye optical module 610 and of the right-eye optical module 620 have mutually orthogonal polarization orientations. The left-eye optical module 610 is configured to be positioned in front of a left eye 675 of the user. Similarly, the right-eye optical module 620 is configured to be positioned in front of a right eye 676 of the user. A light beam carrying an image 670 enters into the left-eye optical module 610 and the right-eye optical module 620. In particular, both optical modules 610, 620 are oriented to receive the light beam by their transparent protective layers. After the left-eye optical module 610 produces a first optical effect on the image 670, the resultant image is seen by the left eye 675 of the user. Similarly, a second optical effect is produced on the image 670 by the right-eye optical module 620 and the resultant image leaving from the right-eye optical module 620 is seen by the right eye 676 of the user. The eyewear 600 further comprises a first electronic driver 630, a digital processing unit 650 and a second electronic driver 660. The first electronic driver 630 supplies a first reference voltage 631 to the third transparent conductive layer of the left-eye optical module 610, a second reference voltage 632 to the third transparent conductive layer of the right-eye optical module 620, a third reference voltage 633 to the second transparent conductive layer of the left-eye optical module 610, and a fourth reference voltage 634 to the second transparent conductive layer of the right-eye optical module 620. Optionally, the first reference voltage 631 may be equal to the second reference voltage 632, and the third reference voltage 633 may be equal to the fourth reference voltage 634. It is also optional that the first, the second, the third and the fourth reference voltages 631-634 may all be equal. According to the first, the second, the third and the fourth reference voltages 631-634, the digital processing unit 650 computes a plurality of digital voltage levels 655 required to drive the first transparent conductive layers and the independently addressable electrode regions of the left-eye optical module 610 and of the right-eye optical module 620 for performing the viewing function that is selected. The second electronic driver 660 receives the plurality of digital voltage levels 655, generates a plurality of driving voltages according to the plurality of digital voltage levels 655, and supplies the plurality of driving voltages to drive the first transparent conductive layers and the independently addressable electrode regions of both optical modules 610, 620. The plurality of driving voltages consists of a first plurality of driving voltages 661 supplied to the independently addressable electrode regions of the left-eye optical module 610, a second plurality of driving voltages 662 supplied to the independently addressable electrode regions of the right-eye optical module 620, a third driving voltage 663 supplied to the first conductive layer of the left-eye optical module 610, and a fourth driving voltage 664 to the first conductive layer of the right-eye optical module 620.

Preferably, the plurality of available viewing functions includes viewing a shutter-based 3D display and viewing a polarization-based 3D display. To configure the eyewear 640 for viewing the shutter-based 3D display, the eyewear 600 further comprises an electronic receiver 640 configured to receive a synchronization signal from the shutter-based 3D display, and the digital processing unit 650 is further configured to receive the synchronization signal from the electronic receiver 640 to thereby compute the plurality of digital voltage levels 655. There are many ways to set the plurality of driving voltages, and the first, the second, the third and the fourth reference voltages 631-634. An example is given as follows. The first reference voltage 631, the second reference voltage 632, the first plurality of driving voltages 661 and the second plurality of driving voltages 662 may all be set to zero volt, thereby permitting light beams that leave the first linear polarizer to transmit through the second linear polarizer for either the left-eye optical module 610 or the right-eye optical module 620. In addition, the third reference voltage 633 and the fourth reference voltage 634 may be set to zero volt, so that the voltage differences experienced by the first liquid crystal layers of the left-eye optical module 610 and of the right-eye optical module 620 depend on the third driving voltage 663 and the fourth driving voltage 664, respectively. Consider a situation that the polarization-based 3D display is viewed and the polarization orientation of the left-eye image is the same as the polarization orientation of the first linear polarizer of the left-eye optical module 610, implying that the polarization orientation of the right-eye image is also the same as the polarization orientation of the first linear polarizer of the right-eye optical module 620. In this situation, the third driving voltage 663 and the fourth driving voltage 664 may be set to the untwisting voltage, in order to allow the left-eye image and the right-eye image to pass through the first liquid crystal layers of the left-eye optical module 610 and of the right-eye optical module 620, respectively. In another situation that the polarization orientation of the left-eye image is orthogonal to the polarization orientation of the first linear polarizer of the left-eye optical module 610 when viewing the polarization-based 3D display, a light beam carrying the left-eye image is required to have an additional 90-degree phase shift in order not to be blocked by the first linear polarizer of the left-eye optical module 610, so that the third driving voltage 663 may be set to zero volt. Similarly, the fourth driving voltage 664 may also be set to zero volt for this situation. Consider a situation that the shutter-based 3D display is viewed and the image 670, which may be a left-eye image or a right-eye image, is carried by a light beam having a polarization orientation the same as the polarization orientation of the first linear polarizer of the left-eye optical module 610, also implying that the polarization orientation of the light beam is orthogonal to the polarization orientation of the first linear polarizer of the right-eye optical module 620. If the image 670 is a left-eye image, the third driving voltage 663 may be set to the untwisting voltage for allowing the image 670 to pass through the first linear polarizer of the left-eye optical module 610, while the fourth driving voltage 664 may also be set to the untwisting voltage to block the image 670 from leaving the first linear polarizer of the right-eye optical module 620. Similarly, if the image 670 is the right-eye image when viewing the shutter-based 3D display, the third driving voltage 663 and the fourth driving voltage 664 may both be set to zero volt. Optionally, the left-eye optical module 610 and the right-eye optical module 620 may be operated independently to block the image 670 to go to both eyes 675, 676 and hence stop the cross-talk produced when a transient switch between the left-eye image to the right-eye image or vice versa when viewing the shutter-based 3D display. In order to block both eyes from seeing the image 670, the first plurality of driving voltages 661 may be set to have a first common voltage, and at the same time instant the second plurality of driving voltages 662 may be set to have a second common voltage, wherein a voltage difference between the first common voltage and the first reference voltage 631 exceeds the untwisting voltage, and a voltage difference between the second common voltage and the second reference voltage 632 exceeds the untwisting voltage. In another case, the third reference voltage 633, the third driving voltage 663, the fourth reference voltage 634 and the fourth driving voltage 664 may be operated to let the image 670 carried by a polarized light beam go to both eyes 675, 676 for non-3D content from a display, given that the first plurality of driving voltages 661 is set to have a third common voltage equal to the first reference voltage 631, and the second plurality of driving voltages 662 is set to have a fourth common voltage equal to the second reference voltage 632. Optionally, the image 670 from the shutter-based 3D display may be carried by a light beam that is not polarized. In this case, the third reference voltage 633, the fourth reference voltage 634, the third driving voltage 663 and the fourth driving voltage 664 may be set at any voltage level, while the first plurality of driving voltages 661 may be set to have a fifth common voltage and the second plurality of driving voltages 662 may be set to have a sixth common voltage. When it is intended that the image 670 is allowed to pass through the left-eye optical module 610, a voltage difference between the fifth common voltage and the first reference voltage 631 may be set to zero volt. When it is intended that the image 670 is blocked from leaving the left-eye optical module 610, a voltage difference between the fifth common voltage and the first reference voltage 631 may be set to a value exceeding the untwisting voltage. When it is intended that the image 670 is allowed to pass through the right-eye optical module 620, a voltage difference between the sixth common voltage and the second reference voltage 632 may be set to zero volt. When it is intended that the image 670 is blocked from leaving the right-eye optical module 620, a voltage difference between the sixth common voltage and the second reference voltage 633 may be set to a value exceeding the untwisting voltage.

Preferably, the plurality of available viewing functions further includes emulating the Pulfrich effect for 3D viewing. To emulate the Pulfrich effect, the left-eye optical module 610 and the right-eye optical module 620 have different degrees of light transmission. Different from viewing a shutter-based or a polarization-based 3D display, the image 670 is carried by a light beam that is not necessarily polarized. There are many ways to set the plurality of driving voltages, and the first, the second, the third and the fourth reference voltages 631-634. An example is given as follows. The first reference voltage 631, the second reference voltage 632, the first plurality of driving voltages 661 and the second plurality of driving voltages 662 may all be set to zero volt, thereby permitting light beams that leave the first linear polarizer to transmit through the second linear polarizer for either the left-eye optical module 610 or the right-eye optical module 620. In addition, the third reference voltage 633 and the fourth reference voltage 634 may be set to zero volt, so that the voltage differences experienced by the first liquid crystal layers of the left-eye optical module 610 and of the right-eye optical module 620 depend on the third driving voltage 663 and the fourth driving voltage 664, respectively. If the image 670 is carried by a light beam that is not polarized, modifying the third driving voltage 663 and the fourth driving voltage 664 does not change the degrees of light transmission of the left-eye optical module 610 and the right-eye optical module 620, respectively. As such, the third driving voltage 663 and the fourth driving voltage 664 may both be set to zero volt. Hence, the first plurality of driving voltages 661 and the second plurality of driving voltages 662 may be set to be different values within zero volt and the untwisting voltage relative to the first reference voltage 631 and the second reference voltage 632, respectively.

Preferably, the plurality of available viewing functions further includes emulating a pair of sunglasses. To emulate the pair of sunglasses, it is required to adjust the left-eye optical module 610 and the right-eye optical module 620 to have a same degree of light transmission less than 100%. Different from viewing a shutter-based or a polarization-based 3D display, the image 670 is carried by a light beam that is not necessarily polarized. There are many ways to set the plurality of driving voltages, and the first, the second, the third and the fourth reference voltages 631-634. An example is given as follows. The first reference voltage 631, the second reference voltage 632, the first plurality of driving voltages 661 and the second plurality of driving voltages 662 may all be set to between zero volt and the untwisting voltage, thereby adjusting intensity of the light beams that leave the first linear polarizer to transmit through the second linear polarizer for either the left-eye optical module 610 and the right-eye optical module 620. In addition, the third reference voltage 633 and the fourth reference voltage 634, relative to the third driving voltage 663 and the fourth driving voltage 664, respectively, may be set to zero volt. If the image 670 is carried by a light beam that is not polarized, adjusting the left-eye optical module 610 and the right-eye optical module 620 to have a same degree of light transmission less than 100% can be achieved by setting the third driving voltage 663 and the fourth driving voltage 664 to a same voltage level within zero volt and the untwisting voltage.

Optionally, the left-eye optical module 610 and the right-eye optical module 620 may provide an additional effect of masking the image 670 by selectively making the liquid crystal cells of the two optical modules 610, 620 opaque according to a masking pattern before being viewed by the left eye 675 and the right eye 676, respectively, of a user.

Preferably, the plurality of available viewing functions further includes emulating a pair of pinhole glasses. In the pair of pinhole glasses, both the left-eye image and the right-eye image are masked by a masking pattern having one or more small holes that allow the passage of light, while the light is blocked outside these small holes. Small apertures of the small holes produce an optical effect that allows a user to view a distant object more clearly, thereby somehow mitigating adverse effects due to the user's short-sightedness, if present. Note that the distant object, presented as the image 670, is carried by a light beam that is not necessarily polarized. There are many ways to set the plurality of driving voltages, and the first, the second, the third and the fourth reference voltages 631-634. An example is given as follows. For simplicity, the first reference voltage 631 and the second reference voltage 632 may be set at zero volt. The first plurality of driving voltages 661 and the second plurality of driving voltages 662 supplied to the independently addressable electrode regions of the matrix-electrode layers of the left-eye optical module 610 and of the right-eye optical module 620, respectively, may be set as follows. According to the masking pattern, the independently addressable electrode regions that correspond to the small holes, which allow passage of light, are provided with zero volt, and the rest of the independently addressable electrode regions are supplied with the untwisting voltage. If the image 670 is carried by a light beam that is polarized, the third reference voltage 633, the fourth reference voltage 634, the third driving voltage 663 and the fourth driving voltage 664 may be set at any voltage level without affecting the viewing function of emulating the pair of pinhole glasses.

A fourth aspect of the present invention is a fourth multi-purpose eyewear reconfigurable for performing a viewing function selected from a plurality of available viewing functions, and a fourth liquid-crystal optical module for realizing this eyewear.

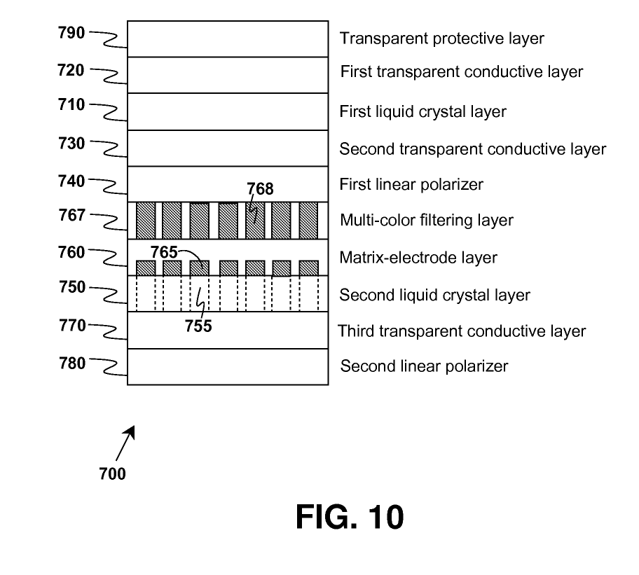

FIG. 10 depicts an optical module 700 according to the fourth aspect of the present invention. The optical module 700 incorporates the disclosed details of the optical module 500 disclosed in the third aspect of this invention, and further comprises a multi-color filtering layer 767 positioned between the first linear polarizer 740 and the matrix-electrode layer 760, wherein the multi-color filtering layer 767 comprises an array of color filters 768 overlying the array of independently addressable electrode regions 765. Preferably, each of the independently addressable electrode regions 765 is covered by a color filter out of the array of color filters 768. Preferably, each of the color filters 768 has a color of either red, green or blue. The colors of the color filters 768 are arranged evenly, or according to one of the known color filter patterns, over the entirety of the color filters 768, thereby allowing three consecutive color filters having colors of red, green and blue to be grouped together as a pixel. It follows that a colorful image is realizable when a white light beam passes through the optical module 700.

The fourth multi-purpose eyewear disclosed herein incorporates the details of the eyewear 600 disclosed above in the third aspect of the present invention, except that each of the left-eye and the right-eye optical modules of the fourth multi-purpose eyewear is realized as the optical module 700 described above.

Preferably, the plurality of available viewing functions includes viewing a shutter-based 3D display and viewing a polarization-based 3D display. Preferably, the plurality of available viewing functions further includes one or more viewing functions selected from emulating the Pulfrich effect for 3D viewing, emulating a pair of pinhole glasses and emulating a pair of sunglasses. Details of configuring the fourth multi-purpose eyewear for viewing the shutter-based 3D display, viewing the polarization-based 3D display, emulating the Pulfrich effect for 3D viewing, emulating the pair of pinhole glasses and emulating the pair of sunglasses are substantially similar to the corresponding details disclosed in the third aspect of this invention.

Preferably, the plurality of available viewing functions further includes viewing an anaglyphic 3D display. As mentioned above, extraction of a left- (right-) eye image from a superimposed image sent out by the anaglyphic 3D display is done by passing the superimposed image through a color filter having a color matched to the color of a light beam that carries the left- (right-) eye image. The fourth multi-purpose eyewear may extract the left- (right-) eye image from the superimposed image by the following setting. A third transparent conductive layer 770 of a left- (right-) eye optical module may be set at zero volt. Zero volt may be applied to a matrix-electrode layer 760's independently addressable electrode regions 765 that overlay color filters 768 having a same color matched to the color of the light beam that carries the left- (right-) eye image, thereby allowing a part of the light beam to pass through liquid crystal cells 755 that attach to these independently addressable electrode regions 765. The untwisting voltage may be applied to remaining independently addressable electrode regions 765 on the matrix-electrode layer 760, so that another part of the light beam entering into liquid crystal cells that attach to these remaining independently addressable electrode regions 765 is blocked.

A fifth aspect of the present invention is to disclose a fifth multi-purpose eyewear reconfigurable for performing a viewing function selected from a plurality of available viewing functions, wherein this eyewear includes a plurality of Fresnel lens to perform one or more optical effects.

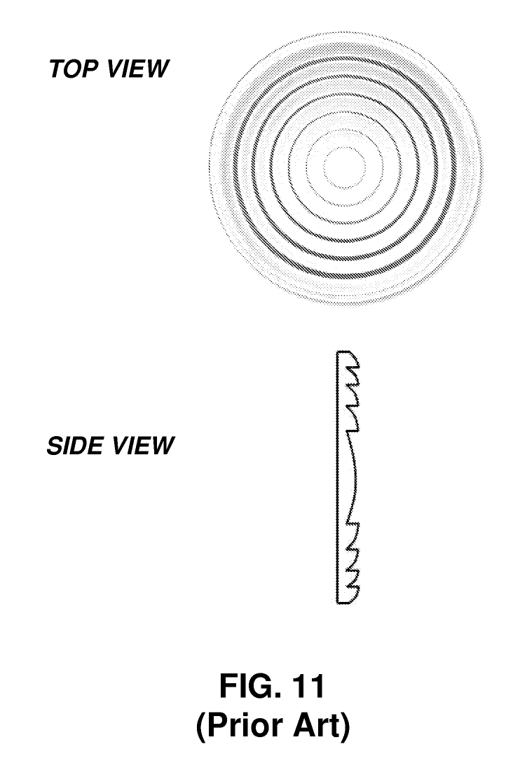

For illustration, FIG. 11 depicts a top view and a side view of a prior-art realization of a Fresnel lens. The Fresnel lens has an advantage for use as a lens having a large aperture and a short focal length in that the mass and the volume of material required to construct the lens are reduced over conventional designs, thereby allowing the Fresnel lens to be thin and light-weight. These two properties make the Fresnel lens advantageous for use in the fifth multi-purpose eyewear disclosed herein.

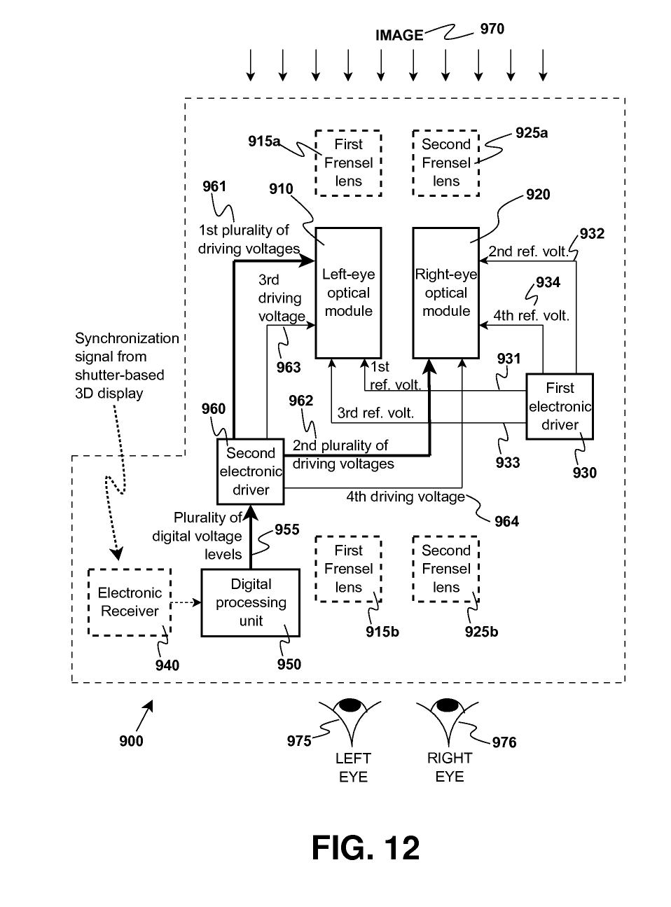

FIG. 12 is a schematic diagram of an eyewear 900 according to the fifth aspect of the present invention. The eyewear 900 incorporates the disclosed details of the fourth multi-purpose eyewear disclosed in the fourth aspect of the present invention, and further comprises a first Fresnel lens 915 and a second Fresnel lens 925. The first Fresnel lens 915 is positioned to be adjacent to either the transparent protective layer or the second linear polarizer of the left-eye optical module 910. If positioned to be adjacent to the transparent protective layer of the left-eye optical module 910, the first Fresnel lens 915a receives an image 970 and passes a resultant image to the left-eye optical module 910. If positioned to be adjacent to the second linear polarizer of the left-eye optical module 910, the first Fresnel lens 915b optically processes an image leaving the left-eye optical module 910 before being seen by a left eye 975. Similarly, the second Fresnel lens 925 is positioned to be adjacent to either the transparent protective layer or the second linear polarizer of the right-eye optical module 920. If positioned to be adjacent to the transparent protective layer of the right-eye optical module 920, the second Fresnel lens 925a receives an image 970 and passes a resultant image to the right-eye optical module 920. If positioned to be adjacent to the second linear polarizer of the right-eye optical module 920, the second Fresnel lens 925b optically processes an image leaving the right-eye optical module 920 before being seen by a right eye 976. Herein in the description of the first Fresnel lens 915 and the second Fresnel lens 925, and in the appended claims, “positioned to be adjacent to” refers to a positional relationship that a first object is close to a second object, but not necessarily that the first object is physically attached to or contacted the second object. In addition, each of the first Fresnel lens 915 and the second Fresnel lens 925 is further characterized by having a focal length that is reconfigurable.

Preferably, the focal lengths of the first Fresnel lens 915 and of the second Fresnel lens 925 may be configured to correct either short-sightedness or long-sightedness, if present, of a user who wears the eyewear 900.

For the fifth multi-purpose eyewear disclosed herein, preferably the plurality of available viewing functions includes viewing a shutter-based 3D display and viewing a polarization-based 3D display. Preferably, the plurality of available viewing functions further includes one or more viewing functions selected from viewing an anaglyphic 3D display, emulating the Pulfrich effect for 3D viewing, emulating a pair of pinhole glasses and emulating a pair of sunglasses. Details of configuring the fifth multi-purpose eyewear for viewing the shutter-based 3D display, viewing the polarization-based 3D display, viewing the anaglyphic 3D display, emulating the Pulfrich effect for 3D viewing, emulating the pair of pinhole glasses and emulating the pair of sunglasses are substantially similar to the corresponding details disclosed in the fourth aspect of this invention.

In one embodiment, the first Fresnel lens 915 of the eyewear 900 is configured to be positioned between the left-eye optical module 910 and the left eye 975 (i.e. the first Fresnel lens 915b in FIG. 12) of a user, and the second Fresnel lens 925 is configured to be positioned between the right-eye optical module 920 and the right eye 976 (i.e. the second Fresnel lens 925b in FIG. 12) of the user. In this embodiment, preferably the plurality of available viewing functions includes viewing a loaded 3D image sequence. When the viewing function of viewing a loaded 3D image sequence is selected, the digital processing unit 950 of the eyewear 900 is further configured to receive a sequence of 3D images where each 3D image consists of a left-eye image and a right-eye image, so that the plurality of digital voltage levels 955 is computed for displaying the left-eye image at the left-eye optical module 910 and the right-eye image at the right-eye optical module 920. Furthermore, the first Fresnel lens 915b optically relocates the left-eye image displayed at the left-eye optical module 910 away from the left eye 975, and the second Fresnel lens 925b optically relocates the right-eye image displayed at the right-eye optical module 920 away from the right eye 976. Such optical relocation is necessary for the user to properly view the left-eye image and the right-eye image; otherwise the two images would appear to be too close to the eyes 975, 976 and the eyes 975, 976 would fail to focus on the two images. Such relocation is achieved through adjustment of the focal lengths of the first Fresnel lens 915b and of the second Fresnel lens 925b.

In this embodiment, preferably the plurality of available viewing functions includes viewing a shutter-based 3D display and viewing a polarization-based 3D display. To configure the eyewear 900 for viewing the shutter-based 3D display, the eyewear 900 further comprises an electronic receiver 940 configured to receive a synchronization signal from the shutter-based 3D display, and the digital processing unit 950 is further configured to receive the synchronization signal from the electronic receiver 940 to thereby compute the plurality of digital voltage levels 955.

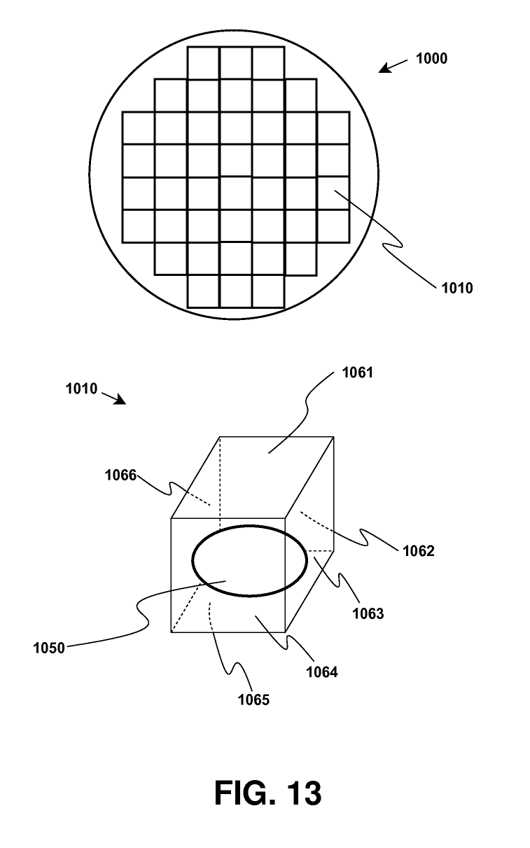

An example to realize a Fresnel lens having a reconfigurable focal length is described with the aid of FIG. 13. In FIG. 13, a Fresnel lens 1000 comprises an array of liquid lenses 1010. In an inset of FIG. 13, an enlarged view of a liquid lens 1010 is shown. The liquid lens 1010 is shaped as a cube comprising six transparent conductive surfaces 1061-1066, wherein the six transparent conductive surfaces 1061-1066 are not electrically connected among themselves. It follows that different voltages may be applied to the six transparent conductive surfaces 1061-1066. Inside the liquid lens 1010, there is a non-conductive liquid drop 1050 that is substantially transparent and has a refractive index greater than that of air. The non-conductive liquid drop 1050 is responsive to the voltages applied to the six transparent conductive surfaces 1061-1066, and changes its shape accordingly. The shape of the liquid drop 1050 determines the liquid drop 1050's power to focus and redirect light beams that enter the liquid lens 1010. To reconfigure the focal length of the Fresnel lens 1000, the focusing and light-redirecting powers may first be determined for the plurality of liquid lenses 1010. The desired voltages for the six transparent conductive surfaces 1061-1066 of each of the liquid lenses 1010 in the Fresnel lens 1000 may then be determined. By applying a plurality of desired voltages to the six transparent conductive surfaces 1061-1066 for all the liquid lenses 1010, the focal length of the Fresnel lens 1000 can be reconfigured as desired.

The present invention may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. Eyewear for enabling a user to view a shutter-based 3D display when a power source is present, or to view a polarization-based 3D display when a power source is absent, the eyewear comprising:
a left-eye optical module and a right-eye optical module, each of which comprises:
(a) a first transparent conductive layer;
(b) a second transparent conductive layer;
(c) a liquid crystal layer positioned between the first and the second transparent conductive layers;
(d) a transparent protective layer attached to the first transparent conductive layer on a surface not attached to the liquid crystal layer; and
(e) a linear polarizer characterized by a polarization orientation, attached to the second transparent conductive layer on a surface not attached to the liquid crystal layer;
an electronic device, configured to:
(a) be powered by a power source;
(b) receive a synchronization signal from the shutter-based 3D display;
(c) supply a first voltage difference between the first and the second transparent conductive layers of the left-eye optical module; and
(d) supply a second voltage difference between the first and the second transparent conductive layers of the right-eye optical module;
characterized in that:
the linear polarizers of the left-eye and of the right-eye optical modules have mutually orthogonal polarization orientations;
when a power source is absent, the electronic device sets both the first voltage difference and the second voltage difference to zero volt, thereby enabling the user to view the polarization-based 3D display; and
when a power source is present, the electronic device sets the first voltage difference and the second voltage difference such that an image is allowed to pass through either the left-eye optical module or the right-eye optical module in accordance with the synchronization signal, thereby enabling the user to view the shutter-based 3D display.

2. The eyewear of claim 1, wherein the electronic device comprises either a radio-frequency wireless receiver or an infra-red receiver for receiving the synchronization signal from the shutter-based 3D display.

3. An optical module comprising:
a transparent conductive layer;
a matrix-electrode layer, comprising an array of independently addressable electrode regions each of which is transparent and electrically conductive;
a liquid crystal layer positioned between the matrix-electrode layer and the transparent conductive layer;
a transparent protective layer attached to the matrix-electrode layer on a surface not attached to the liquid crystal layer; and
a linear polarizer characterized by a polarization orientation, attached to the transparent conductive layer on a surface not attached to the liquid crystal layer.

4. Eyewear for enabling a user to view a 3D display, which is either a shutter-based 3D display or a polarization-based 3D display as selected by the user, the eyewear comprising:
a left-eye optical module and a right-eye optical module each of which is realized as the optical module of claim 3, wherein the linear polarizers of the left- and of the right-eye optical modules have mutually orthogonal polarization orientations;
an electronic receiver configured to receive a synchronization signal from the shutter-based 3D display;
a first electronic driver for supplying a first reference voltage to the transparent conductive layer of the left-eye optical module, and a second reference voltage to the transparent conductive layer of the right-eye optical module;
a digital processing unit, configured to receive the synchronization signal from the electronic receiver, for computing a plurality of digital voltage levels required to drive the independently addressable electrode regions of the left- and the right-eye optical modules for viewing the 3D display that is selected; and
a second electronic driver for receiving the plurality of digital voltage levels, generating a plurality of driving voltages according to the plurality of digital voltage levels, and supplying the plurality of driving voltages to drive the independently addressable electrode regions of both optical modules.

5. An optical module comprising:
a first transparent conductive layer;
a second transparent conductive layer;
a first liquid crystal layer positioned between the first and the second transparent conductive layers;
a transparent protective layer attached to the first transparent conductive layer on a surface not attached to the first liquid crystal layer;
a third transparent conductive layer;
a matrix-electrode layer, comprising an array of independently addressable electrode regions each of which is transparent and electrically conductive;
a second liquid crystal layer positioned between the matrix-electrode layer and the third transparent conductive layer;
a first linear polarizer characterized by a polarization orientation, attached to the second transparent conductive layer on a surface not attached to the first liquid crystal layer, and attached to the matrix-electrode layer on a surface not attached to the second liquid crystal layer; and
a second linear polarizer having a polarization orientation orthogonal to the polarization orientation of the first linear polarizer, the second linear polarizer being attached to the third transparent conductive layer on a surface not attached to the second liquid crystal layer.

6. Eyewear reconfigurable for performing a viewing function selected from a plurality of available viewing functions, the eyewear comprising:
a left-eye optical module and a right-eye optical module each of which is realized as the optical module of claim 5, wherein the polarization orientation of the second linear polarizer of the left-eye optical module is orthogonal to the polarization orientation of the second linear polarizer of the right-eye optical module;
a first electronic driver for supplying a first reference voltage to the third transparent conductive layer of the left-eye optical module, a second reference voltage to the third transparent conductive layer of the right-eye optical module, a third reference voltage to the second transparent conductive layer of the left-eye optical module, and a fourth reference voltage to the second transparent conductive layer of the right-eye optical module;
a digital processing unit for computing a plurality of digital voltage levels required to drive the independently addressable electrode regions and the first transparent conductive layers of the left- and the right-eye optical modules according to the selected viewing function; and
a second electronic driver for receiving the plurality of digital voltage levels, generating a plurality of driving voltages according to the plurality of digital voltage levels, and supplying the plurality of driving voltages to drive the independently addressable electrode regions and the first transparent conductive layers of both optical modules.

7. The eyewear of claim 6, further characterized in that:
the plurality of available viewing functions include viewing a shutter-based 3D display and viewing a polarization-based 3D display;
the eyewear further comprises an electronic receiver configured to receive a synchronization signal from the shutter-based 3D display; and
the digital processing unit is further configured to receive the synchronization signal from the electronic receiver to thereby compute the plurality of digital voltage levels when the selected viewing function is viewing the shutter-based 3D display.

8. The eyewear of claim 7, wherein the plurality of available viewing functions further includes one or more viewing functions selected from emulating the Pulfrich effect for 3D viewing, emulating a pair of pinhole glasses and emulating a pair of sunglasses.

9. The optical module of claim 5, further comprising a multi-color filtering layer positioned between the first linear polarizer and the matrix-electrode layer, wherein the multi-color filtering layer comprises an array of color filters overlying the array of independently addressable electrode regions.

10. Eyewear reconfigurable for performing a viewing function selected from a plurality of available viewing functions, the eyewear comprising:
a left-eye optical module and a right-eye optical module each of which is realized as the optical module of claim 9, wherein the polarization orientation of the second linear polarizer of the left-eye optical module is orthogonal to the polarization orientation of the second linear polarizer of the right-eye optical module;
a first electronic driver for supplying a first reference voltage to the third transparent conductive layer of the left-eye optical module, a second reference voltage to the third transparent conductive layer of the right-eye optical module, a third reference voltage to the second transparent conductive layer of the left-eye optical module, and a fourth reference voltage to the second transparent conductive layer of the right-eye optical module;
a digital processing unit for computing a plurality of digital voltage levels required to drive the independently addressable electrode regions and the first transparent conductive layers of the left- and the right-eye optical modules according to the selected viewing function; and
a second electronic driver for receiving the plurality of digital voltage levels, generating a plurality of driving voltages according to the plurality of digital voltage levels, and supplying the plurality of driving voltages to drive the independently addressable electrode regions and the first transparent conductive layers of both optical modules.

11. The eyewear of claim 10, wherein:
the plurality of available viewing functions includes viewing a shutter-based 3D display and viewing a polarization-based 3D display;
the eyewear further comprises an electronic receiver configured to receive a synchronization signal from the shutter-based 3D display; and
the digital processing unit is further configured to receive the synchronization signal from the electronic receiver to thereby compute the plurality of digital voltage levels when the selected viewing function is viewing the shutter-based 3D display.

12. The eyewear of claim 11, wherein the plurality of available viewing functions further includes one or more viewing functions selected from viewing an anaglyphic 3D display, emulating the Pulfrich effect for 3D viewing, emulating a pair of pinhole glasses and emulating a pair of sunglasses.

13. The eyewear of claim 10, further comprising:
a first Fresnel lens, positioned to be adjacent to either the transparent protective layer or the second linear polarizer of the left-eye optical module; and
a second Fresnel lens, positioned to be adjacent to either the transparent protective layer or the second linear polarizer of the right-eye optical module;
wherein each of the first and the second Fresnel lenses has a focal length that is reconfigurable.

14. The eyewear of claim 13, wherein:
the plurality of available viewing functions includes viewing a shutter-based 3D display and viewing a polarization-based 3D display;
the eyewear further comprises an electronic receiver configured to receive a synchronization signal from the shutter-based 3D display; and
the digital processing unit is further configured to receive the synchronization signal from the electronic receiver to thereby compute the plurality of digital voltage levels when the selected viewing function is viewing the shutter-based 3D display.

15. The eyewear of claim 14, wherein the focal lengths of the first and the second Fresnel lenses are configured to correct either short-sightedness or long-sightedness of a user.

16. The eyewear of claim 15, wherein the plurality of available viewing functions further includes one or more viewing functions selected from viewing an anaglyphic 3D display, emulating the Pulfrich effect for 3D viewing, emulating a pair of pinhole glasses and emulating a pair of sunglasses.

17. The eyewear of claim 13, further characterized in that:
the first Fresnel lens is configured to be positioned between the left-eye optical module and a left eye of a user who wears the eyewear; and
the second Fresnel lens is configured to be positioned between the right-eye optical module and a right eye of the user.

18. The eyewear of claim 17, wherein:
the plurality of available viewing functions includes viewing a loaded 3D image sequence;
the digital processing unit is further configured to receive a sequence of 3D images where each 3D image consists of a left-eye image and a right-eye image, so that the plurality of digital voltage levels is computed for displaying the left-eye image at the left-eye optical module and the right-eye image at the right-eye optical module when the selected viewing function is viewing the loaded 3D image sequence;
the first Fresnel lens optically relocates the left-eye image displayed at the left-eye optical module away from a left eye of a user; and
the second Fresnel lens optically relocates the right-eye image displayed at the right-eye optical module away from a right eye of the user.

19. The eyewear of claim 18, wherein:
the plurality of available viewing functions further includes viewing a shutter-based 3D display and viewing a polarization-based 3D display;
the eyewear further comprises an electronic receiver configured to receive a synchronization signal from the shutter-based 3D display; and
the digital processing unit is further configured to receive the synchronization signal from the electronic receiver to thereby compute the plurality of digital voltage levels when the selected viewing function is viewing the shutter-based 3D display.

20. The eyewear of claim 13, wherein each of the first and the second Fresnel lenses comprises an array of liquid lenses.
